(19) United States
(12) Patent Application Publication
(10) Pub. No.: US 2017/0060508 A1
(43) Pub. Date: Mar. 2, 2017

(54) METHOD, DEVICES AND A SYSTEM FOR GATHERING INFORMATION FOR PROVIDING PERSONALISED AUGMENTED LOCATION INFORMATION

(71) Applicant: Sony Mobile Communications Inc., Tokyo (JP)

(72) Inventors: Mårten Österberg, Lund (SE); Martin Kretz, Malmo (SE)

(21) Appl. No.: 14/835,920

(22) Filed: Aug. 26, 2015

(51) Int. Cl. G06F 3/14; H04W 4/02; H04W 8/18; H04W 4/00; H04M 1/725; G06F 1/16; H04W 8/00

(52) U.S. Cl. CPC G06F 3/14; G06F 1/1613; H04W 4/023; H04W 8/005; H04W 4/008; H04M 1/72572; H04W 8/183

(57) ABSTRACT

The disclosure relates to a method for gathering information for providing personalised augmented information, specifically augmented location information, the method comprising: providing a display arrangement; providing a portable communication device; detecting presence of the portable communication device in the vicinity of the display arrangement; establishing a communications link between the display arrangement and the communication device; assessing if a piece of information concerning the user's identified intentions pertains to a specific location within the environment or a specific resource or a specific person; and displaying on said display arrangement said first information and a second information, the second information comprising an identifier associated with the specific location, resource or person. The disclosure also relates to a display arrangement, a portable communication device and to a system comprising a display arrangement and a portable communication device.

### FIELD OF INVENTION

The inventions relates to a method for gathering information for providing personalised augmented location information.

The invention also relates to a portable communication device being associated with a user.

The invention also relates to a display arrangement being at least semi-stationary and being adapted to display a first information representing an environment, or resources or portable communication devices associated with persons, in said environment, in which or close to which environment the display is located.

The invention also relates to a system for gathering information for providing personalised augmented location information, the system comprising a portable communication device and a display arrangement.

### TECHNICAL BACKGROUND

Getting at-a-glance information has become easy with “Smart Watches” where a user can easy see a reminder when it is time for a meeting. But small displays also have their limits—they are not great a visualizing large graphics, e.g. maps.

### SUMMARY OF INVENTION

It is an object of the invention to provide a method for gathering information for providing personalised augmented information.

This object has been achieved by a method for gathering information for providing personalised augmented information, the method comprising

providing a display arrangement being at least semi-stationary and being adapted to display a first information,

providing a portable communication device which is associated with a user and which stores or has access to information concerning the user or the user's identified intentions,

wherein the display arrangement is adapted to detect presence of the portable communication device or vice versa,

wherein the display arrangement and the communication device are adapted to

establish a communications link,

to assess if a piece of information concerning the user or the user's identified intentions pertains to a specific piece of the first information,

and, if a piece of information concerning the user or the user's identified intentions pertains to a specific piece of the first information, display on said display arrangement said first information and a second information,

the second information comprising an identifier.

The method e.g. makes it possible to gather information for providing personalised augmented information in an example as given below. Imagine a display showing a list of top 10 marathon running results for a race. When a user which participated in the marathon walks past, that specific users results are also displayed on the display arrangement, e.g. at position 27, which would not ordinarily be there. This way the method is augmenting an ordinary list with personalized information based on information associated with the user. This information associated with the user may e.g be the phone number the user noted in the entry form for the marathon. By also displaying a second information comprising an identifier, such as the name, or the start number, or an avatar, it is possible to display this augmented information for more than one user at the time.

It is a further object of the invention to provide a method for gathering information for providing personalised augmented information specifically related to location information.

This object has been achieved by a method for gathering information for providing personalised augmented location information, the method comprising

providing a display arrangement being at least semi-stationary and being adapted to display a first information representing an environment, or resources or portable communication devices associated with persons, in said environment, in which or close to which environment the display is located,

providing a portable communication device which is associated with a user and which stores or has access to information concerning the user's identified intentions,

wherein the display arrangement is adapted to detect presence of the portable communication device or vice versa,

wherein the display arrangement and the communication device are adapted to

establish a communications link,

to assess if a piece of information concerning the user's identified intentions pertains to a specific location within the environment or a specific resource or a specific person,

and, if a piece of information concerning the user's identified intentions pertains to a specific location within the environment or a specific resource or a specific person, display on said display arrangement said first information and a second information,

the second information comprising an identifier associated with the specific location, resource or person.

With this method it is possible to provide personalised augmented location information on a large display. The display may e.g. be a large display e.g. located in the reception of a building or on respective floor in or in the vicinity of an elevator or stair case. The display is typically stationary or at least semi-stationary. It may be noted that the stationary refers in particular to its limited movement relative to the environment. The display may e.g. be positioned in a cruising ship and be adapted to display the environment formed of the corridors, cabins and shared locations and resources on-board the cruising ship. The display is in a sense movable together with the ship but it is stationary relative to the environment represented by the first information.

The portable communication device which is associated with a user and which stores or has access to information concerning the user's identified intentions. The identified intentions may e.g. be appointments in the calendar comprising information about the intended location and the intended participants. The identified intentions may be a reservation of a resource, such as a projector, or other shared resources. The shared resource may be a car in a car pool or a car from a car rental service. The identified intentions may be an entry into a list of tasks, such as “pick up the projector” or “talk to Mr X”. The identified intentions may also be automatically created by monitoring of searches performed by the user via internet search providers or by monitoring visited web-pages or by monitoring bookmarked web-pages, or the like. The identified intentions may be related to information directly stored on the communication device or automatically created via actions performed using the communication device. Alternatively or as a complement thereto the identified intentions may be related to information stored on or created from actions performed on other user associated device to which the portable communication device has access. The access may be continuous or intermittent.

When the user carrying the portable communication device comes within a predetermined distance from the display arrangement which in a preferred embodiment is acting as a beacon, the communication device detects the presence of the display arrangement and a communications link is established.

By comparing data or pieces of information related to the an environment, or resources or portable communication devices associated with persons, in said environment with data or pieces of information concerning the user's identified intentions the communication device and/or display arrangement establish if a piece of information concerning the user's identified intentions pertains to a specific location within the environment or a specific resource or a specific person.

This may e.g. be the case when a specific meeting room, i.e. a location is specified as part of the environment and this meeting room is also specified as an intended meeting room for an appointment in the user's calendar. This comparison preferably also involves establishment if there is a time set for the appointment and a comparison with the actual time to determine if the actual time is within a predetermined range from the time set for the appointment.

An affirmative answer to the comparison may also be noted if a communication device associated with another user which is also an intended participant for the same meeting is within the environment.

An affirmative answer to the comparison may also be noted if a communication device associated with another person who is identified in the task list or otherwise identified is identified as being within the environment.

An affirmative answer to the comparison may also be noted if a resource identified in a task list or appointment is identified as being within the environment.

If a piece of information concerning the user's identified intentions pertains to a specific location within the environment or a specific resource or a specific person, the display arrangement is adapted to apart from said first information also display a second information comprising an identifier associated with the specific location, resource or person.

The display may e.g. display a map showing the environment and display the meeting room in a different colour and provide a label indicating the name of the meeting room. Thereby the display normally displaying a map displays personalised augmented location information.

Preferred embodiments appear in the dependent claims and in the description. It may be noted that due to formal reasons the dependent claims refer to the first independent claim but it is contemplated that any preferred embodiment disclosed in a dependent claim may be combined with any other preferred embodiment disclosed in any other dependent claims unless directly contradictory.

The second information may further comprise an identifier associated with the user being displayed in association with the displaying of the specific location, resource or person. The identifier associated with the user may e.g. be a so-called avatar, a picture or any other kind of information recognisable by the user as information being associated with him/her.

By using an identifier associated with the user, it is possible for the display arrangement to display personalised augmented location information for more than one user at the same time. It may e.g. display the identifier of a first user in the representation of the meeting room where the first user has an appointment and display the identifier of a second user in the representation where a resource booked by the second user is located.

The display arrangement may have a communications beacon broadcasting its identifier. A beacon functionality draws energy and since the display arrangement typically is connected to mains it is preferred that the beacon is provided at the display arrangement side of the system. The beacon may be a Bluetooth beacon, and is preferably a Bluetooth low energy beacon. Alternatively the detection of the communication device being in the vicinity of a display, the communication device could find its position using other ways of positioning (such as via multiple Bluetooth low energy beacons) and with the resulting location coordinates, look up if any display is nearby. A server, or the device itself, could have a list of displays with coordinates to look at. RFID reader and tags may be used as an alternative to the beacons. One advantage with RFID is that the tag can be used passively.

The display arrangement may be adapted to display a routing from a present location of the display arrangement or the communication device to the specific location, resource or person.

In accordance with the method it may also be detected when the communication device has been removed from the display arrangement a predetermined distance and in response thereto terminating the displaying of the second information. Thereby the personalised augmented location information is not shown any longer when the user moves away from the display arrangement. As an alternative or complement thereto it may be possible to terminate the displaying of the second information after a specific time frame.

The system may also provide different levels of privacy. Some identified intensions may be set to never appear on the display arrangement. Others may be set to appear if no-one else is detected as being nearby. Others may be set to always appear independently on the presence of others or not. Other kinds of privacy settings may also be used.

It is a further object of the invention to provide a portable communication device being set-up for gathering information for providing personalised augmented location information.

This object has been achieved by a portable communication device being associated with a user,

wherein the device stores or has access to information concerning the user's identified intentions,

wherein the device is adapted to detect presence of a display arrangement or vice versa,

wherein the communication device is adapted to establish a communications link with the display arrangement and together with the display arrangement assess if a piece of information concerning the user's identified intentions pertains to a specific location within the environment or a specific resource or a specific person.

The advantages and function thereof has been discussed above in relation to the method.

The portable communication device may, if a piece of information concerning the user's identified intentions pertains to a specific location within the environment or a specific resource or a specific person, send to said display arrangement a second information, wherein the second information comprising an identifier associated with the user.

It is a further object of the invention to provide a display arrangement being set-up for gathering information for providing personalised augmented location information.

This object has been achieved by a display arrangement being at least semi-stationary and being adapted to display a first information representing an environment, or resources or portable communication devices associated with persons, in said environment, in which or close to which environment the display is located,

wherein the display arrangement is adapted to detect presence of a portable communication device or vice versa, wherein the communication device is associated with a user and stores or has access to information concerning the user's identified intentions

wherein the display arrangement is adapted to establish a communications link with the communication device,

and together with the communication device to assess if a piece of information concerning the user's identified intentions pertains to a specific location within the environment or a specific resource or a specific person,

and, if a piece of information concerning the user's identified intentions pertains to a specific location within the environment or a specific resource or a specific person, display on said display arrangement said first information and a second information,

the second information comprising an identifier associated with the specific location, resource or person.

The advantages and function thereof has been discussed above in relation to the method.

The display arrangement may adapted to receive from the communication device a further piece of the second information comprising an identifier associated with the user and displaying it in association with the displaying of the specific location, resource or person.

The display arrangement has preferably a communications beacon broadcasting its identifier.

The beacon is preferably a Bluetooth beacon, and more preferably a Bluetooth low energy beacon.

The display arrangement may be adapted to display a routing from a present location of the display arrangement or the communication device to the specific location, resource or person.

The display arrangement may be adapted to detect when the communication device has been removed from the display arrangement a predetermined distance and in response thereto terminating the displaying of the second information.

It is a further object of the invention to provide a system being set-up for gathering information for providing personalised augmented location information.

This object has been achieved by a system for gathering information for providing personalised augmented location information, the system comprising a portable communication device in accordance with any embodiment discussed above and a display arrangement in accordance with any embodiment discussed above.

### BRIEF DESCRIPTION OF THE DRAWINGS

The invention will by way of example be described in more detail with reference to the appended schematic drawings, which shows a presently preferred embodiment of the invention.

FIG. 1 schematically discloses a floor plan.

FIG. 2-3 schematically discloses a display.

FIG. 4 schematically discloses a system.

FIG. 5 schematically illustrates the method.

### DETAILED DESCRIPTION OF PREFERRED EMBODIMENTS

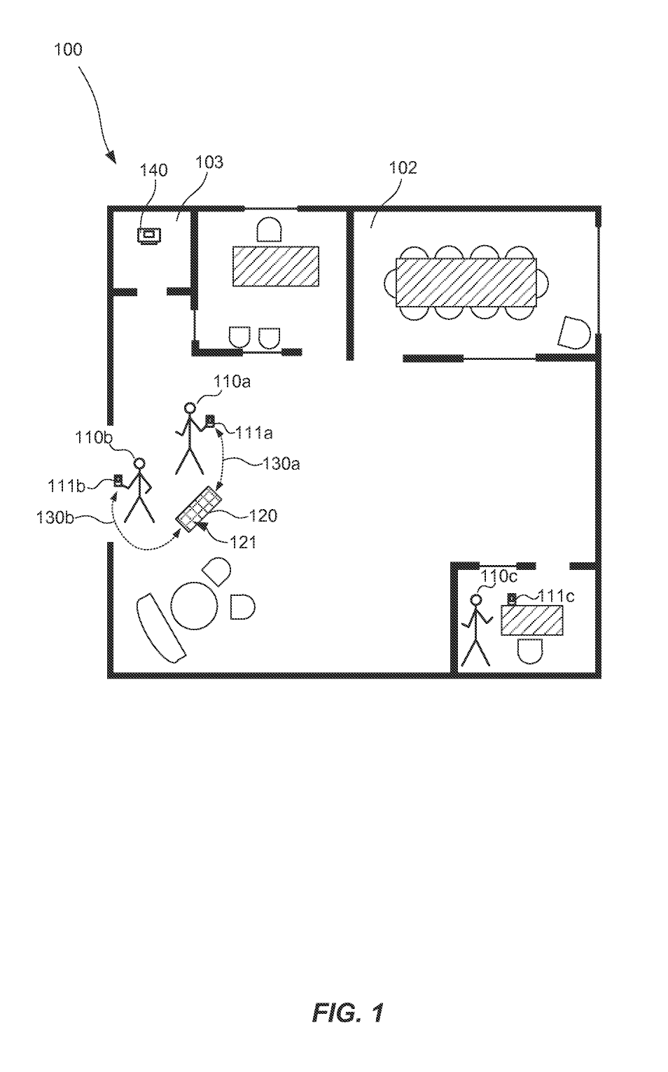

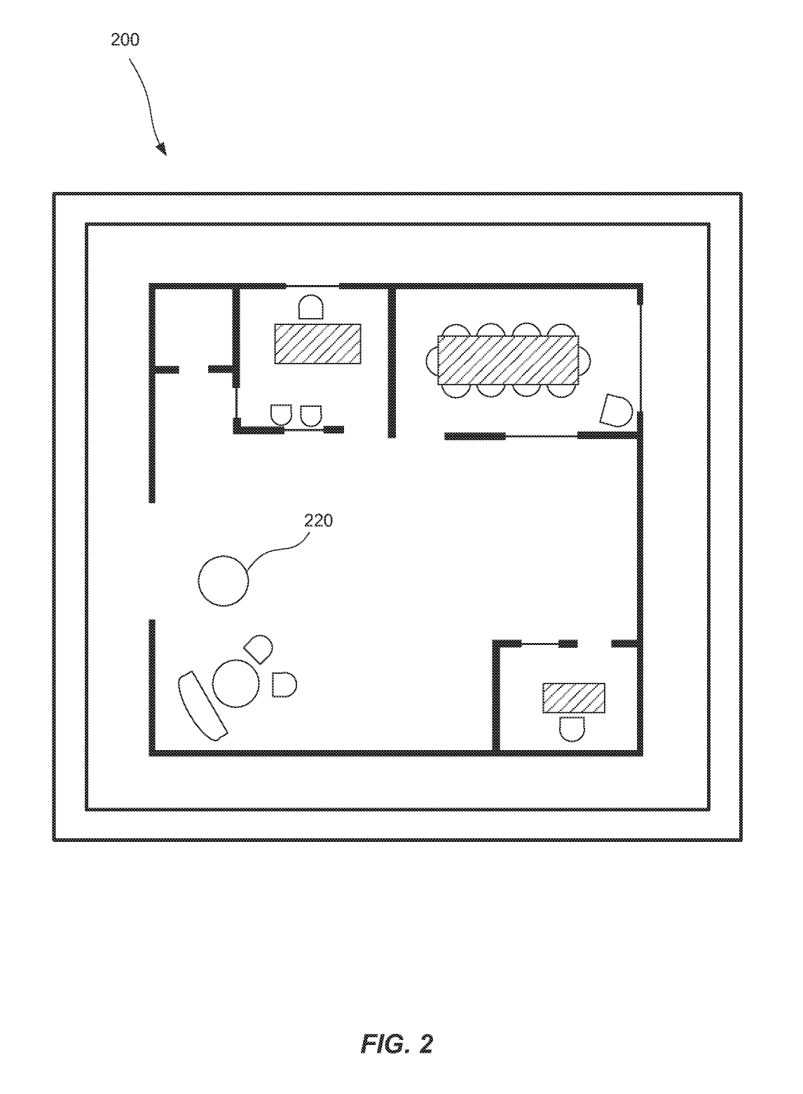

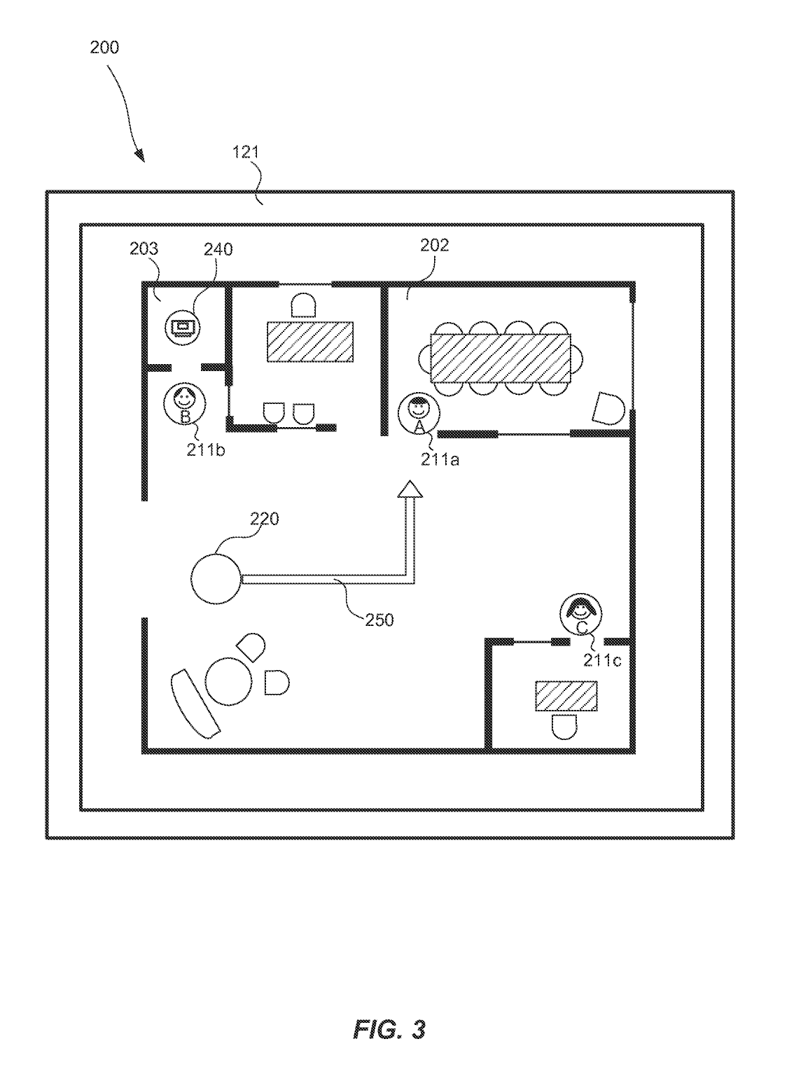

FIG. 1 discloses a floor plan 100 in which a display arrangement 120 is located. In FIGS. 2-3 the screen 200 of the display arrangement 120 is shown. FIG. 1 depicts the real life and FIGS. 2-3 depict the representation displayed on the display arrangement 120. Reference numerals of objects present in real life has been given reference numerals 1xx and their representation in on the display has been given reference numerals 2xx where applicable.

As shown in FIG. 2, the display arrangement 120 is arranged to normally display a representation of the floor plan 100 and to indicate with a dot 220 or any other suitable shape the location of the display arrangement 120 in the representation 200 of the floor plan 100.

When a first user 110a carrying a portable communication device 111a comes within a predetermined distance d from the display arrangement 120, the communication device 111a detects the presence of the display arrangement 120 and a first communications link 130a between the first communication device 111a and the display arrangement 120 is established.

The display arrangement 120 stores information or has access to information concerning the names and locations of different meeting rooms or other shared resources. By comparing data or pieces of information related to e.g. the names of meeting rooms in the environment, with data or pieces of information concerning the user's appointments (meeting in a room with a given name), the communication device 111 and/or display arrangement 120 establish if a piece of information concerning the user's appointment pertains to a meeting room within the environment.

If it has been established that the environment 100 contains a meeting room 102 in which the user 10a is scheduled to attend a meeting, the representation 202 of meeting room 102 is highlighted by associating a second information 211a on the display 121 as shown in FIG. 3. The second information 211a may e.g. be an avatar associated with the first user 111a. The second information 211a is overlaid or shown in association with the representation 202 of the meeting room 102 on the display 121.

An affirmative answer to the comparison may also be noted if a communication device 111c associated with another user 110c which is also an intended participant for the same meeting is within the environment 100.

On the representation 200 this other user 110c may be indicated as an avatar 211c in a location associated with the location of the communication device 111c. A similar representation may be used if an affirmative answer to the comparison is reached if a communication device associated with another person who is identified in the task list or otherwise identified is identified as being within the environment.

An affirmative answer to the comparison may also be noted if a resource 140, such as a projector or the like, is identified in a task list or appointment is identified as being within the environment 100. In the representation 200 the location of the resource 140 is represented e.g. by a picture 240 of the resource 140 in the representation 203 of the actual location 103 of the resource 140. If more than user uses the display arrangement simultaneously it may be useful to display information identifying which user is intended to retrieve which resource. In the example of FIG. 3, the user 111b has booked the resource 140 and the display arrangement 120 displays in the representation 200 an avatar 211b in association with the representation 240 of the resource 140. In general terms these avatars or pictures of the users or resources may be said to be second information comprising an identifier associated with the specific location, resource or person.

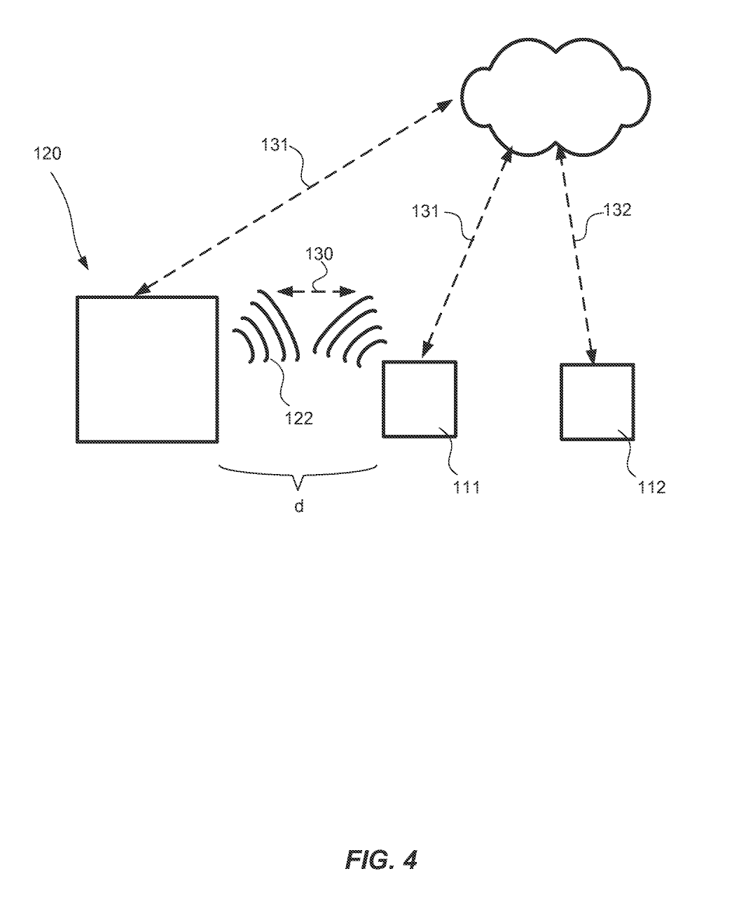

As briefly indicated in FIG. 4, the display arrangement 120 has a communications beacon 122 broadcasting its identifier. The beacon is a Bluetooth beacon, preferably a Bluetooth low energy beacon.

As shown in FIG. 3, the display arrangement is adapted to display a routing 250 from a present location of the display arrangement or the communication device to the specific location, resource or person. This may be useful in large or complex sites. The communications link 130 may be directly from device to device as indicated by line 130 in FIG. 3 or via a cloud service as indicated by lines 131 in FIG. 3. When using a cloud service communications link 13, information may also be retrieved from a further unit 112 also in communicating with the cloud service via another communications link 132

It is detected, preferably by the display arrangement 120, when the communication device 111 has been removed from the display arrangement a predetermined distance and in response thereto the displaying of the second information associated with that communication device 111 is terminated.

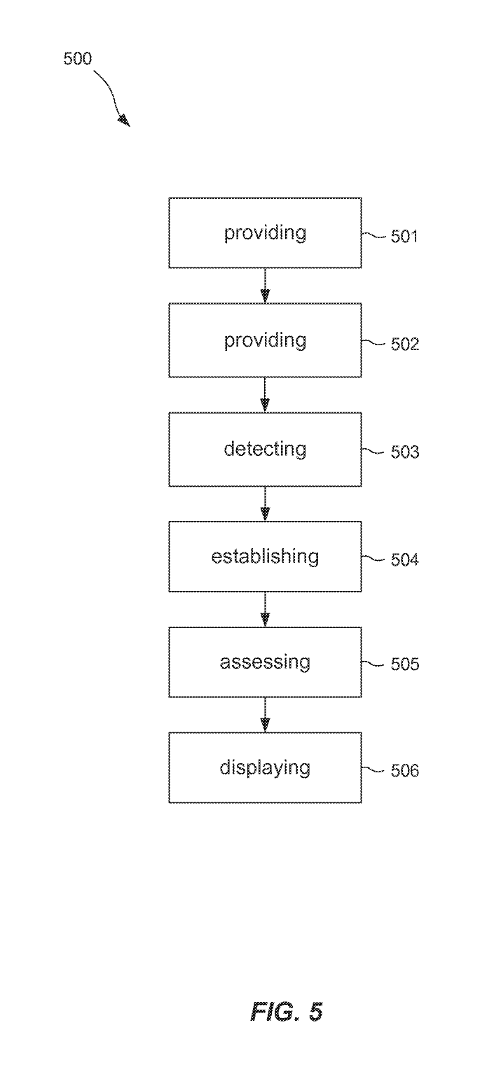

FIG. 5 briefly shows the steps of the method 500;

providing 501 a display arrangement 120,

providing 502 a portable communication device 111,

detecting 503 presence of the portable communication device 111 in the vicinity of the display arrangement 120,

establishing 504 a communications link 130 between the display arrangement 120 and the communication device 111,

assessing 505 if a piece of information concerning the user's identified intentions pertains to a specific location within the environment or a specific resource or a specific person, and

displaying 506 on said display arrangement said first information and a second information, the second information comprising an identifier associated with the specific location, resource or person.

It is contemplated that there are numerous modifications of the embodiments described herein, which are still within the scope of the invention as defined by the appended claims. The display arrangement 120 may for instance also display other kinds of information retrieved from the communications device and/or from the memory of the display arrangement, such as the time of the meeting or time to the beginning of the meeting, distance from the present location to the meeting room, expected time to walk to the meeting room, etc.

1. Method for gathering information for providing personalised augmented information, the method comprising
providing a display arrangement being at least semi-stationary and being adapted to display a first information,
providing a portable communication device which is associated with a user and which stores or has access to information concerning the user or the user's identified intentions,
wherein the display arrangement is adapted to detect presence of the portable communication device or vice versa,
wherein the display arrangement and the communication device are adapted to
establish a communications link,
to assess if a piece of information concerning the user or the user's identified intentions pertains to a specific piece of the first information,
and, if a piece of information concerning the user or the user's identified intentions pertains to a specific piece of the first information, display on said display arrangement said first information and a second information,
the second information comprising an identifier.

2. Method according to claim 1, for gathering information for providing personalised augmented location information, wherein
the first information represents an environment, or resources or portable communication devices associated with persons, in said environment, in which or close to which environment the display is located,
wherein the portable communication device which is associated with a user stores or has access to information concerning the user's identified intentions,
wherein in the assessing it is assessed if a piece of information concerning the user's identified intentions pertains to a specific location within the environment or a specific resource or a specific person,
and, if a piece of information concerning the user's identified intentions pertains to a specific location within the environment or a specific resource or a specific person, display on said display arrangement said first information and a second information,
the second information comprising an identifier associated with the specific location, resource or person.

3. Method according to claim 2, wherein the second information further comprising an identifier associated with the user being displayed in association with the displaying of the specific location, resource or person.

4. Method according to claim 1, wherein the display arrangement has a communications beacon broadcasting its identifier.

5. Method according to claim 4, wherein the beacon is a Bluetooth beacon, preferably a Bluetooth low energy beacon.

6. Method according to claim 2, wherein the display arrangement is adapted to display a routing from a present location of the display arrangement or the communication device to the specific location, resource or person.

7. Method according to claim 1, further comprising detecting when the communication device has been removed from the display arrangement a predetermined distance and in response thereto terminating the displaying of the second information.

8. Portable communication device being associated with a user,
wherein the device stores or has access to information concerning the user's identified intentions,
wherein the device is adapted to detect presence of a display arrangement or vice versa,
wherein the communication device is adapted to establish a communications link with the display arrangement and together with the display arrangement assess if a piece of information concerning the user's identified intentions pertains to a specific location within the environment or a specific resource or a specific person.

9. Portable communication device according to claim 8, wherein, if a piece of information concerning the user's identified intentions pertains to a specific location within the environment or a specific resource or a specific person, send to said display arrangement a second information,
wherein the second information comprising an identifier associated with the user.

10. Display arrangement being at least semi-stationary and being adapted to display a first information representing an environment, or resources or portable communication devices associated with persons, in said environment, in which or close to which environment the display is located,
wherein the display arrangement is adapted to detect presence of a portable communication device or vice versa, wherein the communication device is associated with a user and stores or has access to information concerning the user's identified intentions
wherein the display arrangement is adapted to establish a communications link with the communication device,
and together with the communication device to assess if a piece of information concerning the user's identified intentions pertains to a specific location within the environment or a specific resource or a specific person,
and, if a piece of information concerning the user's identified intentions pertains to a specific location within the environment or a specific resource or a specific person, display on said display arrangement said first information and a second information,
the second information comprising an identifier associated with the specific location, resource or person.

11. Display arrangement according to claim 10, wherein the display arrangement is adapted to receive from the communication device a further piece of the second information comprising an identifier associated with the user and displaying it in association with the displaying of the specific location, resource or person.

12. Display arrangement according to claim 10, wherein the display arrangement has a communications beacon broadcasting its identifier, preferably a Bluetooth beacon, more preferably a Bluetooth low energy beacon.

13. Display arrangement according to claim 10, wherein the display arrangement is adapted to display a routing from a present location of the display arrangement or the communication device to the specific location, resource or person.

14. Display arrangement according to claim 10, wherein the display arrangement is adapted to detect when the communication device has been removed from the display arrangement a predetermined distance and in response thereto terminating the displaying of the second information.

15. System for gathering information for providing personalised augmented location information, the system comprising a portable communication device being associated with a user and a display arrangement according to claim 10,
wherein the device stores or has access to information concerning the user's identified intentions,
wherein the device is adapted to detect presence of a display arrangement or vice versa,
wherein the communication device is adapted to establish a communications link with the display arrangement and together with the display arrangement assess if a piece of information concerning the user's identified intentions pertains to a specific location within the environment or a specific resource or a specific person.
